(19) United States
(12) Patent Application Publication
(10) Pub. No.: US 2026/0082221 A1
(43) Pub. Date: Mar. 19, 2026

(54) SYSTEMS AND METHODS FOR ESTABLISHING SHARED TRUST FOR OUTBOUND CALLS

(71) Applicant: Wells Fargo Bank, N.A., San Francisco, CA (US)

(72) Inventors: Shawn Patrick Clark, Hastings, MN (US); Angela Sicord, San Francisco, CA (US); Matthew N. Wheeler, Charlotte, NC (US)

(21) Appl. No.: 18/886,920

(22) Filed: Sep. 16, 2024

(51) Int. Cl. H04W 12/06; H04M 3/42

(52) U.S. Cl. CPC H04W 12/06; H04M 3/42059

(57) ABSTRACT

Systems, apparatuses, methods, and computer program products are disclosed for establishing shared trust between an agent and a user for an outbound call. An example method includes receiving an outbound call request from an agent device and determining whether the user device is eligible for the mobile verify authentication routine. The example method further includes generating a mobile verify event for the outbound call and performing the mobile verify authentication routine. The mobile verify routine includes generating a call session context for the outbound call, providing a call confirmation request to the user device, receiving a call confirmation response from the user device, generating an authentication status for the user, and providing a user authentication message to the agent device, wherein the user authentication message comprises the authentication status.

### BACKGROUND

Entity representatives or agents may need to speak with a user for a variety of reasons. A portion of these calls may require the user to provide sensitive or private information. However, there is currently no definitive means for a user to confirm that a received call is with a legitimate agent.

### BRIEF SUMMARY

As described above, there is currently no means for a user to verify the identity of an agent for a call the user receives. Currently, the recommended standard is for the user who receives such an outbound call to hang up and call a phone number known to legitimately be associated with the entity, such as a phone number listed on the entity's website. However, this can be time consuming and may require the user to navigate through a call routing system to reach an agent. Furthermore, the user may not be reconnected with the particular agent who initially performed the outbound call and is familiar with the user's information and/or the reason for the call. As such, while this may be the current safest option, this standard has numerous drawbacks, such as being resource inefficient and causing user frustration. Alternatively, if the user continues with the received call, the user risks potentially exposing sensitive information to a bad actor. Furthermore, even if the user is on a call with a legitimate entity agent, revealing sensitive information on a received call may predispose the user to providing such information on non-legitimate calls, thereby increasing of the risk of the user being scammed. Thus, these traditional approaches have been one-sided and fail to provide the user with any confirmation regarding the identity of the agent. Thus, traditional approaches may leave users vulnerable to fraudulent activity, such as phishing scams or impersonation scams.

The inherent blind spots and limitations associated with establishing shared trust for an outbound call presents a technical problem. As such, a need exists for a solution that (i) securely authenticates a user for an outbound call without requiring the user to expose sensitive information to the agent/caller and (ii) securely verifies the authenticity of the outbound call to ensure the call is legitimate. Example embodiments provide a technical solution to this technical problem because example embodiments do not require the user to reveal sensitive information to the caller and further, ensure that the outbound call is currently anticipated for the user. Furthermore, the mobile verify authentication routine provides a technical solution that streamlines the authentication process for a user by leveraging the capabilities of the user's associated user device, bolsters trust between the user and the agent, and enhances security for the participants of the call. As such, example embodiments described herein allow for shared trust to be established between a user using a user device and an agent using an agent device.

Example embodiments described herein may ensure that a mobile verify authentication routine may be performed for the outbound call. In doing so, a shared trust verification system may conserve computational resources by first determining the eligibility of the user and/or user device for the mobile verify authentication routine prior to attempting to perform operations associated with the routine. In particular, the shared trust verification system may receive an outbound call request from an agent device and the outbound call request may be indicative of a request for a mobile verify authentication routine to be performed for the outbound call. The shared trust verification system may then identify user device parameters associated with the user device of the user and determine whether these user device parameters satisfy mobile verify requirement criteria. In some embodiments, the mobile verify requirement criteria may ensure that the user device is capable of performing associated mobile verify authentication routine operations and/or that the user device is inferred to be a trusted user device that is legitimately associated with the user. In an instance in which the shared trust verification system determines the user device is eligible for the mobile verify authentication routine, the shared trust verification system may generate a mobile verify event for the outbound call and assign the event an active event status.

In some embodiments, the shared trust verification system may receive the outbound call request from the agent device prior to the agent device performing the outbound call with the user device. As such, the shared trust verification system may optionally provide an outbound call notification to the user device to proactively alert the user of the upcoming call, thereby instilling confidence in the authenticity of the call for the recipient user. Alternatively, the shared trust verification system may receive the outbound call request from the agent device after the agent device has called the user device and the agent and user are connected. This may allow the shared trust verification system to operate in an efficient manner by first ensuring the agent and user are currently on a call prior to performing subsequent operations, thereby conserving computational resources. Furthermore, once the shared trust verification system receives the outbound call request from the agent device, the shared trust verification system may perform the subsequent operations, such as determining the user device eligibility, generating a mobile verify event, handling a logon request from the user device, and/or performing the mobile verify authentication routine, in real-time or near real-time. In doing so, the shared trust verification system may ensure the user is authenticated for the call in a timely and efficient manner such that the call may proceed without significant delay. Timely operation performance is particularly important for calls between an agent and user because the remainder or substance of the call may not be performed until the user is authenticated via the mobile verify authentication routine.

Prior to performing the mobile verify authentication routine, the shared trust verification system may further ensure that a logon request received from the user device has successfully been authenticated and that a mobile verify event corresponding to the outbound call is associated with an active status. In doing so, the shared trust verification system ensures that the (i) the user device is capable of performing subsequent required actions within an associated software application and (ii) the outbound call is still valid. In some embodiments, the mobile verify event may only be valid for a predefined time period to help maintain user account security. As such, the mobile verify event may be updated to an inactive event status in an instance in which an elapsed time since the mobile verify event was generated fails to satisfy an elapsed time threshold. Alternatively, the shared trust verification system may receive a cancellation request for the outbound call from the agent device and may automatically update the mobile verify event to an inactive status upon receipt of such a cancellation request.

Once the shared trust verification system ensures the logon request has been successfully authenticated and the mobile verify event is associated with an active status, the shared trust verification system may perform the mobile verify authentication routine. In particular, the shared trust verification system may generate call session context for the outbound call and provide a call confirmation request that includes this call session context to the user device within the associated software application. The call confirmation request may include instructions that cause the user device to prompt the user to provide input to either confirm or deny whether he/she has received a call from the agent. The call session context may further aid the user in determining whether the call they are on is legitimate by providing a reason for the call, agent information about the agent on the call, associated content and/or documents pertaining to the call, and/or the like. Thus, the user may review the call session context and determine whether to confirm the call. The shared trust verification system may receive a call confirmation response from the user device that is indicative of whether the user affirmatively confirmed receipt of the call. If the user did affirmatively confirm receipt of the call, the shared trust verification system may determine the user has been successfully authenticated and generate a positive authentication status for the user. Otherwise, the shared trust verification system may determine the user has failed to be successfully authenticated and may determine a negative authentication status for the user. The shared trust verification system may then provide a user authentication message that includes the authentication status of the user to the agent device. As such, the agent may automatically be made aware of the current authentication status of the user and can proceed to take appropriate action on the call. Thus, the mobile verify authentication routine may automatically authenticate the user via an associated software application and further, provide the result to the agent without requiring the agent and user to exchange sensitive information. Furthermore, the user maybe provided with agent information within the call session context included in the call confirmation request to verify the identity of the agent for the user.

Furthermore, in some embodiments, in an instance in which the user is associated with a positive authentication status, the shared trust verification system may generate an authentication trust category for the user. The authentication trust category may be representative of a level of trust in the authentication of the user. The authentication trust category may also be provided in the user authentication message to the agent device such that the agent is also made aware of an authentication level for the user. In some embodiments, the agent may perform certain operations and/or actions for the user based on the authentication trust category. In doing so, the authentication trust category provides flexibility to the operations that may be performed for a user on the call, thereby increasing the robustness of the mobile verify authentication routine while maintaining security for an associated user account.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates an example system in which some example embodiments may be used to establish shared trust between a user and an agent.

FIG. 2 illustrates a schematic block diagram of example circuitry embodying a shared trust verification system that may perform various operations in accordance with some example embodiments described herein.

FIG. 3 illustrates a schematic block diagram of example circuitry embodying a user device and/or agent that may perform various operations in accordance with some example embodiments described herein.

FIG. 4 illustrates an example flowchart for determining whether a mobile verify authentication routine can be performed for an outbound call, in accordance with some example embodiments described herein.

FIG. 5 illustrates an example flowchart for determining whether a user device is eligible for the mobile verify authentication routine, in accordance with some example embodiments described herein.

FIG. 6 illustrates another example flowchart for determining whether to update an event status of the mobile verify event, in accordance with some example embodiments described herein.

FIG. 7 illustrates another example flowchart for performing the mobile verify authentication routine, in accordance with some example embodiments described herein.

FIGS. 8A and 8B illustrate a swim lane diagram with example operations that may be performed by components of the environment depicted in FIG. 1, in accordance with some example embodiments described herein.

FIG. 9 illustrates an example user interface depicting an example call confirmation response as used in some example embodiments described herein.

FIG. 10 illustrates an example user interface depicting example call context after a user has provided affirmative confirmation of receipt of the outbound call, as used in some example embodiments described herein.

FIG. 11 illustrates an example user interface for a customer authentication tool viewable by an agent during the outbound call, as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

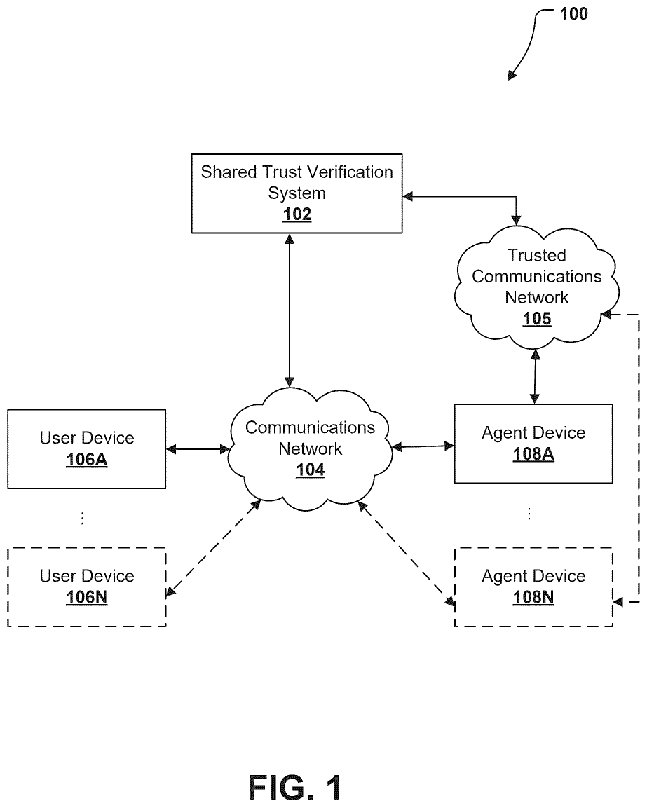

Example embodiments described herein may be implemented using any of a variety of computing devices or servers. To this end, FIG. 1 illustrates an example environment 100 within which various embodiments may operate. As illustrated, a shared trust verification system 102 may receive and/or transmit information via communications network 104 (e.g., the Internet) with any number of other devices, such as one or more of user devices 106A-106N and/or agent devices 108A-108N. Additionally, the shared trust verification system 102 may receive and/or transmit information via trusted communications network 105 (e.g., an Intranet), which may be a private or restricted communication environment within which only certain, authorized devices may communication. The shared trust verification system 102 and one or more of the agent devices 108A-108N may be authorized devices and may receive and/or transmit information via trusted communications network 105.

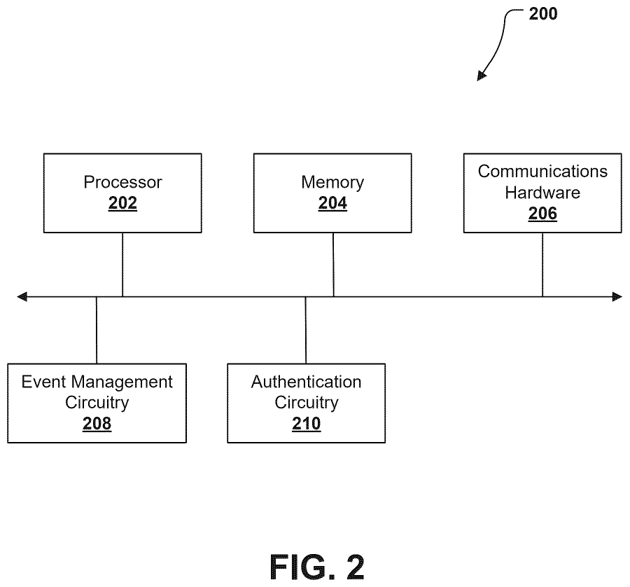

The shared trust verification system 102 may be implemented as one or more computing devices or servers, which may be composed of a series of components. Particular components of the shared trust verification system 102 are described in greater detail below with reference to apparatus 200 in connection with FIG. 2.

In some embodiments, the shared trust verification system 102 further includes a storage device that comprises a distinct component from other components of the shared trust verification system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104 or trusted communications network 105). The storage device may host the software executed to operate the shared trust verification system 102. The storage device may store information relied upon during operation of the shared trust verification system 102, such as data and documents to be analyzed using the shared trust verification system 102 or the like. In addition, the storage device may store control signals, device characteristics, and access credentials enabling interaction between the shared trust verification system 102 and one or more of the user devices 106A-106N and/or agent devices 108A-108N.

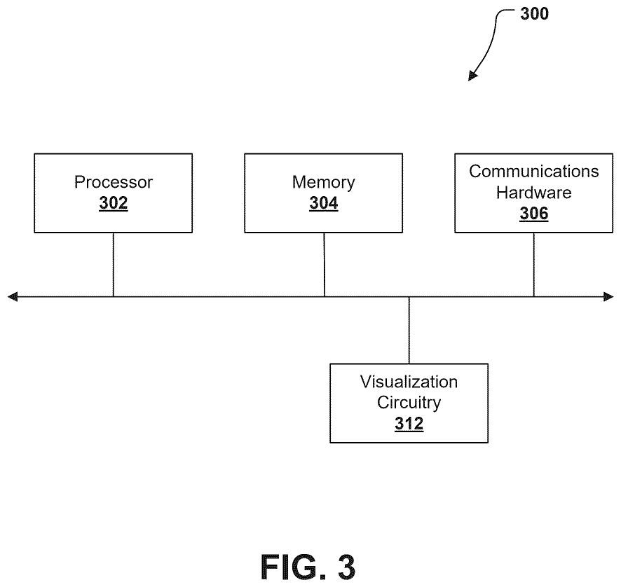

The one or more user devices 106A-106N and the one or more agent devices 108A-108N may be embodied by any computing devices known in the art. The one or more user devices 106A-106N and the one or more agent devices 108A-108N need not themselves be independent devices but may be peripheral devices communicatively coupled to other computing devices. In some embodiments, a user device (e.g., any one of user devices 106A-106N) may be associated with a user who is associated with a user account maintained by the shared trust verification system 102 (e.g., a customer). In some embodiments, an agent device (e.g., any one of agent devices 108A-108N) may be associated with an agent who is an authorized user associated with the shared trust verification system 102 (e.g., an employee of the entity associated with the shared trust verification system 102). Particular components of the user device (e.g., any one or user devices 106A-106N) and/or the agent device (e.g., any one of agent devices 108A-108N) are described in greater detail below with reference to apparatus 300 in connection with FIG. 3.

Although FIG. 1 illustrates an environment and implementation in which the shared trust verification system 102 interacts indirectly with a user via one or more of user devices 106A-106N and/or agent devices 108A-108N, in some embodiments users may directly interact with the shared trust verification system 102 (e.g., via communications hardware of the shared trust verification system 102), in which case a separate user device 106A-106N and/or agent device 108A-108N may not be utilized. Whether by way of direct interaction or indirect interaction via another device, a user may communicate with, operate, control, modify, or otherwise interact with the shared trust verification system 102 to perform the various functions and achieve the various benefits described herein.

### Example Implementing Apparatuses

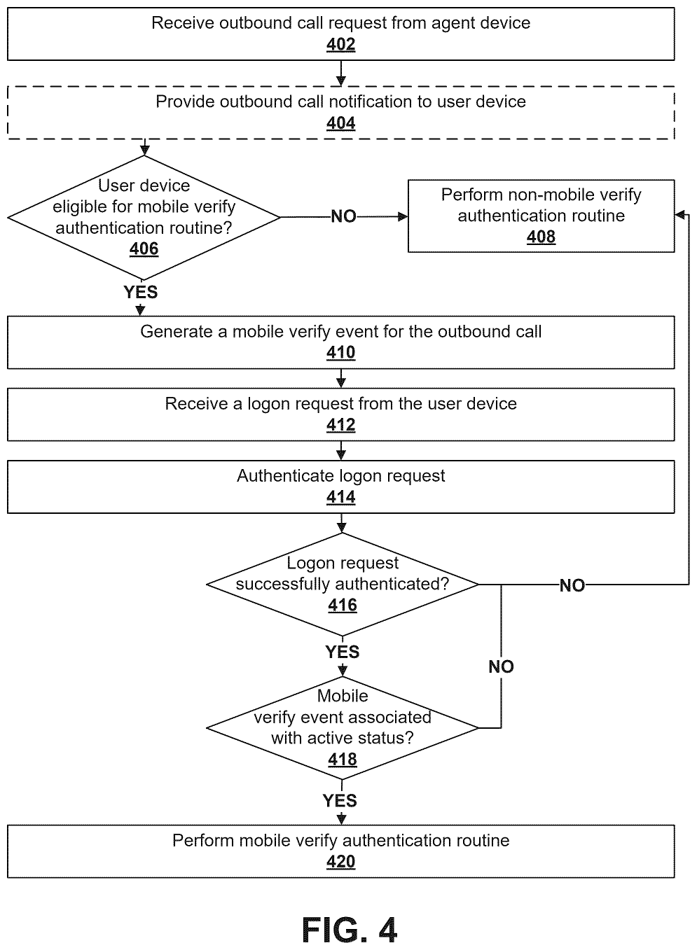

The shared trust verification system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-7 As illustrated in FIG. 2, the apparatus 200 may include processor 202, memory 204, communications hardware 206, event management circuitry 208, and authentication circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud”processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises event management circuitry 208 that may be configured to determine whether a user device is eligible for a mobile verify authentication routine, generate a mobile verify event, identify user device parameters, determine an elapsed time for the mobile verify event, update an event status for the mobile verify event, generate call session context for an outbound call, and/or the like. The event management circuitry 208 may utilize processor 202, memory 204, or any other hardware component included in the apparatus 200 to perform these operations, as described in connection with FIGS. 4-7 below. The event management circuitry 208 may further utilize communications hardware 206 to gather data from a variety of sources (e.g., user device 106A-106N and/or agent devices 108A-108N, as shown in FIG. 1), and/or exchange data with a user and/or agent.

In addition, the apparatus 200 further comprises authentication circuitry 210 that may be configured to authenticate a logon request, determine an authentication status for a user, determine an authentication trust category for the user, and/or the like. The authentication circuitry 210 may utilize processor 202, memory 204, or any other hardware component included in the apparatus 200 to perform these operations, as described in connection with FIGS. 4-7 below. The authentication circuitry 210 may further utilize communications hardware 206 to gather data from a variety of sources (e.g., user device 106A-106N and/or agent devices 108A-108N, as shown in FIG. 1), and/or exchange data with a user and/or agent.

Although components 202-208 are described in part using functional language, it will be understood that the particular implementations necessarily include the use of particular hardware. It should also be understood that certain of these components 202-208 may include similar or common hardware. For example, the event management circuitry 208 and authentication circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the event management circuitry 208 and authentication circuitry 210 may leverage processor 202, memory 204, or communications hardware 206 as described above, it will be understood that any of event management circuitry 208 and authentication circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that event management circuitry 208 and authentication circuitry 210 comprise particular machinery designed for performing the functions described herein in connection with such elements of apparatus 200.

As illustrated in FIG. 3, an apparatus 300 is shown that represents an example user device (e.g., any of user devices 106A-106N) or an example agent device (e.g., any of agent devices 108A-108N). The apparatus 300 includes processor 302, memory 304, and communications hardware 306, each of which is configured to be similar to the similarly named components described above in connection with FIG. 2. However, the apparatus 300 may also include visualization circuitry 312, which includes hardware components configured to display received data, notifications, messages, and/or the like. In some embodiments, visualization circuitry 312 may cause data from received communications (e.g., an outbound call notification, a call confirmation request, a user authentication message, or the like) to be displayed in a software application or within the internal account environment and render various elements in the software application environment or internal account environment. The visualization circuitry 312 may utilize processor 302, memory 304, or any other hardware component included in the apparatus 300 to perform these operations, as described in connection with FIGS. 4-7 below. The visualization circuitry 312 may further utilize communications hardware 306 to gather data from a variety of sources (e.g., shared trust verification system 102, user devices 106A-106N, and/or agent devices 108A-108N, as shown in FIG. 1), and/or exchange data with a user or agent.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

Turning to FIGS. 4-7, example flowcharts are illustrated that contain example operations implemented by example embodiments described herein. The operations illustrated in FIGS. 4-7 may, for example, be performed by the shared trust verification system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, event management circuitry 208, authentication circuitry 210, and/or any combination thereof. It will be understood that user interaction with the shared trust verification system 102 may occur directly via communications hardware 206, or may instead be facilitated by a separate user device (e.g., any one of user device 106A-106N) and/or an agent device (e.g., any one of agent devices 108A-108N), as shown in FIG. 1, and which may have similar or equivalent physical componentry facilitating such user interaction.

Turning first to FIG. 4, example operations are shown for determining whether to perform a mobile verify authentication routine for an outbound call. As shown by operation 402, the apparatus 200 includes means, such as memory 204, communications hardware 206, or the like, for receiving an outbound call request from an agent device. The outbound call request may be indicative of a request for a mobile verify authentication routine to be performed for the outbound call. The communications hardware 206 may receive the outbound call request from an agent device, such as agent device 108A. In some embodiments, the outbound call request may be received in response to an agent selecting a user to call and/or obtaining a phone number associated with an associated user device, such as user device 106A, of the user. In some embodiments, the outbound call request may be received using a hypertext transfer protocol (HTTP) or HTTP secure (HTTPS) protocol (e.g., an HTTP/HTTPS request) In some embodiments, the agent may be an authorized user (e.g., an employee, contractor, or other authorized party) associated with permissions to access user account information within an internal account environment. In particular, an agent may be associated with an agent account, which may include information about the agent (e.g., name, email, title, role, department, and/or the like) and may be stored and maintained in an associated memory (e.g., memory 204 or another data repository). The agent account may further be associated with an agent identifier (e.g., a username, email, employee number, and/or the like) and agent credentials (e.g., a password, biometric data, personal identification number, and/or the like).

In order to access the internal account environment, an agent device 108A may provide an agent identifier and candidate agent credentials to the communications hardware 206. The authentication circuitry 210 may then identify the agent account using the provided agent identifier and authenticate the agent user based on the candidate agent credentials and stored agent credentials associated with the agent account. In an instance the authentication circuitry 210 determines the provided candidate agent credentials match or otherwise satisfy requirements associated with the stored agent credentials, the authentication circuitry 210 may determine that the agent has been successfully authenticated and may allow agent device 108A to access the internal account environment. The agent user account may also include a set of permissions that allow the agent to access certain data or information within apparatus 200 that other unauthorized users would not be able to access. For example, a set of permissions associated with the agent user may allow the agent to use agent device 108A to access user information (e.g., user account information) within an internal account environment, such as via trusted communications network 105.

Once agent device 108A has access to the internal account environment, the agent may navigate the internal account environment to select a user with whom he/she would like to call. In some embodiments, selection of the user to call may automatically cause an associated user device 106A to be selected by agent device 108A or the agent may provide user input to select an associated user device to call. This may cause agent device 108A to obtain an identifier for user device 106A. In some embodiments, the identifier is a phone number for the user device 106A. The identifier may also be associated with user device identifiers, such as a media access control (MAC) address, internet protocol (IP) address, international mobile equipment identity (IMEI) number, a mobile equipment identifier (MEID), a universally unique identifier (UDID), a hardware identifier, an electronic serial number, or any other identifier which uniquely identifies the particular user device 106A. In some embodiments, a user account for a corresponding user may further be associated with one or more user devices profiles corresponding to user devices associated with the user. In some embodiments, a device profile may include one or more identifiers as well as user device identifiers for the user device. Additionally, or alternatively, a device profile may include additional device information such as an associated device trust score, a user device type, a consent to call category, an indication or log of when the user device previously accessed the user account via an associated software application, and/or the like.

As described above, the communications hardware 206 may receive the outbound call request from agent device 108A. This outbound call request may be received once the agent has selected and finalized a user and/or user device for an outbound call. The outbound call request may additionally include the identifier (e.g., a phone number) that identifies a user device associated with the user for the outbound call. In some embodiments, the communications hardware 206 may receive the outbound call request from agent device 108A prior to agent device 108A performing the outbound call with user device 106A. Alternatively, the communications hardware 206 may receive the outbound call request from agent device 108A after agent device 108A has called user device 106A and the agent and user are connected. In some embodiments, the outbound call request may further include a flag or other indicator that is indicator of whether the outbound call has been performed.

It will be appreciated that in some embodiments, agent device 108A may perform an outbound call with a user device that is a different user device than the user device indicated by the outbound call request and/or that will participate in a mobile verify authentication routine.

For example, an agent device 108A may perform an outbound call to user device 106N but user device 106A may be indicated by the outbound call request, may provide a logon request, and/or participate in the mobile verify authentication routine.

Optionally, as shown by operation 404, the apparatus 200 includes means, such as communications hardware 206 or the like, for providing an outbound call notification to the user device. In some embodiments, upon receipt of the outbound call request from the agent device, the communications hardware 206 may provide the outbound call notification to the selected user device 106A. The outbound call notification may alert or serve to provide a warning to the user of the upcoming call. In some embodiments, the outbound call notification may further provide information regarding the call, such as the estimated time the user device will receive the upcoming call, agent information, context session context for the call, and/or the like. As such, the user who is a recipient of the upcoming outbound call may receive a notification of the call prior to receiving the call, which may help instill confidence in the authenticity of the call for the recipient user. In some embodiments, the outbound call notification may be provided in an instance in which the outbound call request from agent device 108A is received prior to the outbound call.

The communications hardware 206 may provide the outbound call notification to user device 106A over any suitable communications channel. In some embodiments, the outbound call notification may be provided as a push notification via an associated software application. Additionally, or alternatively, the outbound call notification may be provided as a short message service (SMS) message, an email, etc.

As shown by operation 406, the apparatus 200 includes means, such as event management circuitry 208 or the like, for determining whether the user device is eligible for a mobile verify authentication routine. In response to receipt of the outbound call request, the event management circuitry 208 may determine whether user device 106A indicated by the outbound call request is eligible for the requested mobile verify authentication routine. In particular, the event management circuitry 208 may identify one or more user device parameters associated with the user device and determine whether these one or more user devices parameters satisfy mobile verify requirement criteria. In an instance in which the one or more user device parameters are determined to satisfy the mobile verify requirement criteria, the event management circuitry 208 may determine user device 106A is eligible for the mobile verify authentication routine. Otherwise, in an instance in which the one or more user device parameters fail to satisfy the mobile verify requirement criteria, the event management circuitry 208 may determine user device 106A is not eligible for the mobile verify authentication routine.

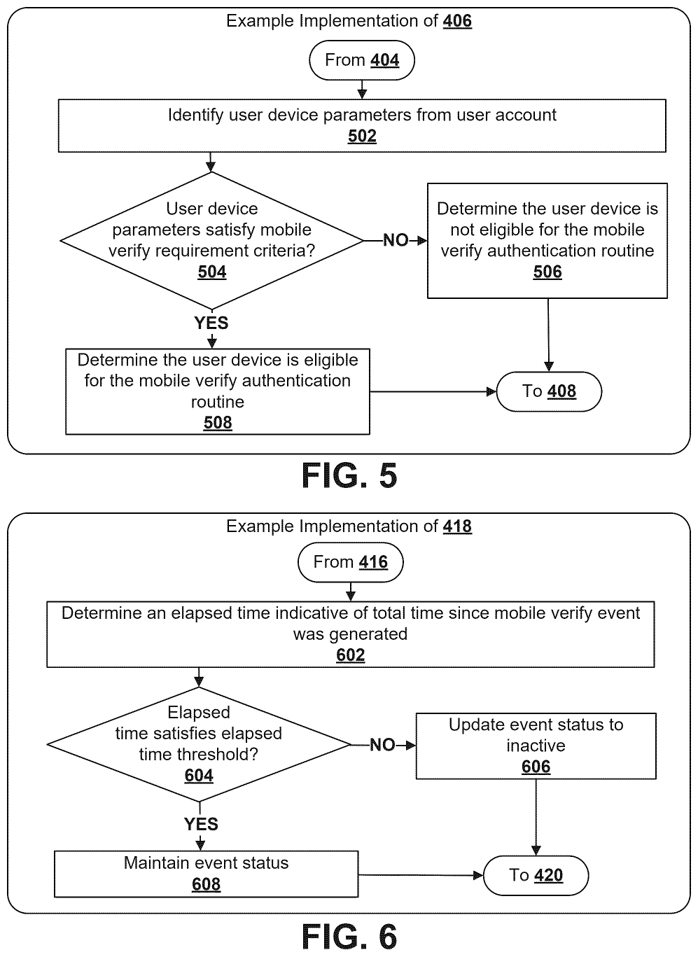

In some embodiments, operation 406 may be performed in accordance with the operations described by FIG. 5. Turning now to FIG. 5, example operations are shown for determining whether the user device is eligible for the mobile verify authentication routine based on user device parameters.

As shown by operation 502, the apparatus 200 includes means, such as event management circuitry 208 or the like, for identifying user device parameters from a user account. As described above, in some embodiments, a user account for the user may be associated with a user devices profile corresponding to user device 106A. A device profile may include one or more identifiers and/or user device identifiers, an associated device trust score, a user device type, a consent to call category, an indication or log of when user device 106A previously accessed the user account via an associated software application, and/or the like. The event management circuitry 208 may identify at least a portion of the information from the user device profile as user device parameters. In some embodiments, the event management circuitry 208 may identify the particular user device parameters that are required by or pertain to the mobile verify requirement criteria.

As shown by operation 504, the apparatus 200 includes means, such as event management circuitry 208 or the like, for determining whether the user device parameters satisfy mobile verify requirement criteria. Once the event management circuitry 208 has identified the user device parameters from the user account, the event management circuitry 208 may determine whether the user device parameters satisfy the mobile verify requirement criteria. In some embodiments, the mobile verify requirement criteria may define one or more requirements that must be satisfied in order for the event management circuitry 208 to determine user device 106A is eligible for the mobile verify authentication routine. In an instance in which each requirement of the mobile verify requirement criteria is satisfied, the event management circuitry 208 may determine the user device is eligible for the mobile verify authentication routine. Alternatively, in an instance in which a requirement of the mobile verify requirement criteria fails to be satisfied, the event management circuitry 208 may determine the user device is not eligible for the mobile verify authentication routine.

In some embodiments, the mobile verify requirement criteria may require that user device 106A has previously accessed the user account via an associated software application. This requirement may ensure that user device 106A is capable of facilitating a mobile verify authentication routine via an associated software application. In particular, as discussed in greater detail in operation 412 of FIG. 4, the communications hardware 206 may receive a logon request from user device 106A. In order to provide this logon request, user device 106A must have an associated software application installed. Thus, the event management circuitry 208 may determine whether user device 106A has previously accessed the associated user account via the software application, and this may serve as an indication of whether the user device is configured with the required software application. As such, the event management circuitry 208 may determine whether a user device parameter is indicative that user device 106A has previously accessed the user account via the software application. In an instance in which the user device has previously accessed the user account via the software application, the event management circuitry 208 may determine this requirement is satisfied.

In some embodiments, the event management circuitry 208 may additionally determine whether the user device has accessed the user account via the software application within a predefined time window (e.g., within the past day, week, month, or the like). The event management circuitry 208 may determine whether an associated log and/or timestamp described by a user device parameter is indicative that user device 106A accessed the user account via the software application within the predefined time window. This requirement may ensure that user device 106A is currently configured with the required software application. In an instance in which the user device accessed the user account via the software application within the predefined time window, the event management circuitry 208 may determine this requirement is satisfied.

In some embodiments, the mobile verify requirement criteria may require that the user account is indicative of consent to receive outbound calls. In some embodiments, the event management circuitry 208 may determine whether the user device parameter is indicative of a permissive consent to call category for the user device. For example, a device profile and/or user account may be associated with a consent to call category. The consent to call category may be indicative of whether the user has opted in to receive outbound calls related to his/her user account and/or on the particular user device that received or is intended to receive the outbound call. By way of particular example, a consent to call category may either be permissive, non-permissive, prohibited, and/or the like. As such, the event management circuitry 208 may determine whether the consent to call category associated with the user and/or user device is a permissive consent to call category. In an instance in which the user and/or user device is associated with a permissive consent to call category, the event management circuitry 208 may determine this requirement is satisfied.

In some embodiments, the mobile verify requirement criteria may require that user device 106A is associated with a trusted user device status. In some embodiments, the event management circuitry 208 may determine whether the user device is associated with a trusted user device status. In some embodiments, the device profile for the user device may include an associated device trust score. A device trust score may be indicative of an inferred amount of trust or confidence that the user device is legitimately associated with or belongs to the user. In some embodiments, the device trust score may be a numerical value that falls within a range. The event management circuitry 208 may determine whether user device 106A is associated with a trusted user device status based on the associated device trust score. In particular, in some embodiments, the event management circuitry 208 may determine whether the device trust score satisfies a device trust score threshold. In an instance the device trust score satisfies a device trust score threshold, the event management circuitry 208 may determine user device 106A is associate with a trusted user device status.

In an instance in which the user device parameters fail to satisfy the mobile verify requirement criteria, the process proceeds to operation 506. As shown by operation 506, the apparatus 200 includes means, such as event management circuitry 208 or the like, for determining the user device is not eligible for the mobile verify authentication routine. As described above, in an instance in which a requirement of the mobile verify requirement criteria fails to be satisfied, the event management circuitry 208 may determine the user device is not eligible for the mobile verify authentication routine.

In an instance in which the user device parameters are determined to satisfy the mobile verify requirement criteria, the process proceeds to operation 508. As shown by operation 508, the apparatus 200 includes means, such as event management circuitry 208 or the like, for determining the user device is eligible for the mobile verify authentication routine. In an instance in which each requirement of the mobile verify requirement criteria is satisfied, the event management circuitry 208 may determine the user device is eligible for the mobile verify authentication routine.

Returning now to FIG. 4, in an instance in which the user device is determined to not be eligible for the mobile verify authentication routine, the process proceeds to operation 408. As shown by operation 408, the apparatus 200 includes means, such as communications hardware 206, authentication circuitry 210, or the like, for performing a non-mobile verify authentication routine for the outbound call. In an instance in which user device 106A is determined to not be eligible for the mobile verify authentication routine, the authentication circuitry 210 may perform a non-mobile verify authentication routine for the outbound call. The non-mobile verify authentication routine may prompt the agent to ask one or more questions to verify the identity of the user. In some embodiments, the agent may manually compare user responses to user responses stored in the user account. The communications hardware 206 may receive an authentication decision from agent device 108A indicative of whether the agent successfully authenticated the user based on the user responses. As such, the authentication circuitry 210 may authenticate the user based on the authentication decision. Alternatively, in some embodiments, the agent may be required to enter user responses into the internal account environment and the authentication circuitry 210 may compare the user responses to the user responses stored in the user account to automatically determine whether the user is authenticated. An indication of whether the user was successfully verified may be presented to the agent.

Additionally, in an instance in which the user device was determined to not be eligible for the mobile verify authentication routine, the communications hardware 206 may provide a message to agent device 108A and/or user device 106A to directly or indirectly alert the user that the mobile verify authentication routine may be available for future calls. In some embodiments, the message may further include an indication of the one or more requirements of the mobile verify requirement criteria that failed to be satisfied. As such, the user may proactively take action with respect to their user account and/or user device to satisfy the currently unsatisfied requirements such that a mobile verify authentication routine may be enabled for future outbound calls.

In an instance in which the user device is determined to be eligible for the mobile verify authentication routine, the process proceeds to operation 410. As shown by operation 410, the apparatus 200 includes means, such as event management circuitry 208, or the like, for generating a mobile verify event for the outbound call. In an instance in which the event management circuitry 208 determines the user device is eligible for the mobile verify authentication routine, the event management circuitry 208 may generate a mobile verify event for the outbound call. The mobile verify event may include an event status that is indicative of whether the mobile verify event is currently active. The mobile verify event may further be associated with a generation timestamp that is indicative of the time the mobile verify event was generated. In some embodiments, the mobile verify event may be representative of the status or authenticity of the outbound call and/or the agent. The mobile verify event may be stored and/or maintained in an associated memory, such as memory 204.

In some embodiments, the event management circuitry 208 may generate the mobile verify event for the outbound call without first determining whether the user device is eligible for the mobile verify authentication routine. Rather, the event management circuitry 208 may generate the mobile verify event for the outbound call upon receipt of the outbound call request from the agent device, as described in operation 402.

In some embodiments, the event management circuitry 208 may generate the mobile verify event to include outbound call request details. For example, the mobile verify event may include a user identifier, a device identifier for user device 106A, an agent identifier, a device identifier for agent device 108A, and/or the like. As such, the mobile verify event may be linked to the agent and user and can be identified for subsequent operations related to the outbound call. In some embodiments, the mobile verify event may be stored in association with the user account.

As shown by operation 412, the apparatus 200 includes means, such as memory 204, communications hardware 206, or the like, for receiving a logon request from the user device. Communications hardware 206 may receive a logon request from the user device 106A when a user attempts to log into a user account using an associated software application. In some embodiments, the logon request may be a request to access the user account within the software application. In some embodiments, the software application is a mobile application or a native application that is configured to execute on user device 106A.

In some embodiments, the agent may prompt the user to provide the logon request while connected on the call. For example, in some embodiments, once the event management circuitry 208 has generated the mobile verify event for the call, agent device 108A may receive a notification that the mobile verify event has been generated. In some embodiments, agent device 108A may provide this notification to the agent and the agent may in turn, prompt the user to use their user device 106A to log into an associated user account using the software application to allow for a mobile verification routine to be performed.

The logon request may include a candidate user identifier (e.g., a username, email, customer number, and/or the like) and candidate user credentials (e.g., a passkey, a password, biometric data, personal identification number (PIN), and/or the like). Additionally, or alternatively, the logon request may include an indication of user device 106A. For example, the logon request may include a device identifier, such as a MAC address, IP address, IMEI number, phone number, a MEID, a UDID, a hardware identifier, an electronic serial number, or any other identifier that uniquely identifies the particular user device. In some embodiments, the logon request may be received using a hypertext transfer protocol (HTTP) or HTTP secure (HTTPS) protocol (e.g., an HTTP/HTTPS request).

As shown by operation 414, the apparatus 200 includes means, such as authentication circuitry 210 or the like for authenticating the logon request. In some embodiments, authentication circuitry 210 may perform the authentication routine to authenticate the logon request for user account as received from the user device (e.g., user device 106A). In some embodiments, the authentication circuitry 210 may authenticate the logon request received from user device 106A based on the received candidate user credentials and stored user credentials associated with the user account. In particular, the authentication circuitry 210 may use the candidate user identifier to determine associated stored user credentials. In an instance in which each of the received candidate user credentials sufficiently match the corresponding stored user credentials, the authentication circuitry 210 may successfully authenticate the user and the logon request. Alternatively, in instance in which the received candidate user credentials fails to sufficiently match the stored user credentials, the authentication circuitry 210 may fail to authenticate the user and the logon request.

For example, for a candidate user credential that is a password, the authentication circuitry 210 may use a hashing function to hash the characters of the candidate password and then compare the hashed candidate password to a hashed stored password. In an instance in which the corresponding characters of the hashed candidate password and hashed stored password exactly match, the authentication circuitry 210 may determine the candidate user credentials sufficiently match the stored user credentials.

In some embodiments, the authentication circuitry 210 may use one or more models to determine whether the candidate user credentials sufficiently match the stored user credentials. For example, in an instance in which a candidate user credential corresponds to biometric data (e.g., fingerprint data, facial image data, retina data, or the like), the authentication circuitry 210 may be configured to use one or more biometric matching machine learning models to determine whether a similarity score between biometric data of the candidate user credential and corresponding biometric data of the stored user credential. In an instance in which the similarity score satisfies one or more similarity thresholds, the authentication circuitry 210 may determine that the candidate user credential sufficiently matches the stored user credential.

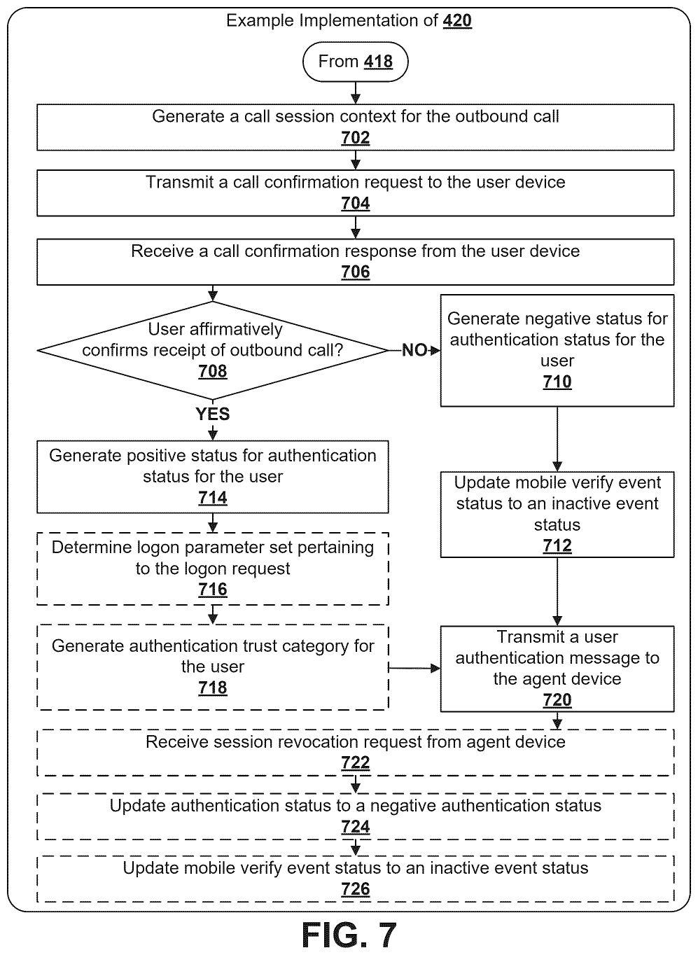

In some embodiments, the particular authentication protocol used to authenticate the logon request may be stored in an associated memory, such as memory 204, for use in later operations as described in operations 716 and 718 of FIG. 7. The authentication protocol may describe the user credential type of the user credentials provided in the logon request, algorithms or models used in the authentication, associated matches or authentication scores (e.g., similarity scores), a number of logon request reattempts received from user device 106A, and/or the like.

In some embodiments, the logon request may be received from user device 106A via the software application using a HTTP or HTTPS protocol and may be a request to access a user account within the software application. Once the logon request has been successfully authenticated, the communications hardware 206 may provide a response (e.g., an HTTP/HTTPS response) that includes user account data for the user account to the software application running on user device 106A. In some embodiment, the communications hardware 206 may use specific application program interfaces (APIs), such as representational state transfer APIs (RESTful APIs) or WebSocket APIs to provide user account data to the software application.

Once the user account data is provided to the software application running on user device 106A, an authenticated session may be successfully established. The authenticated session may continue until a termination event occurs. A termination event may be the user logging out of the session. Alternatively, the termination event may be a timeout event, where the software application running on the user device 106A experiences a period of inactivity for a length of time that exceeds an inactivity time threshold (e.g., 10 minutes). In an instance a termination event occurs, the user may be required to provide another logon request to establish a new authenticated session or re-establish the authenticated session.

As shown by operation 416, the apparatus 200 includes means, such as authentication circuitry 210 or the like for determining whether the logon request was successfully authenticated. As described in operation 414, the authentication circuitry 210 may perform an authentication routine to determine whether to authenticate the logon request received in operation 412.

In an instance in which the logon request failed to be authenticated, the process proceeds to operation 408. As previously described, at operation 408, the authentication circuitry 210 may perform a non-mobile verify authentication routine for the outbound call. If the logon request fails to be authenticated, user device 106A will be unable to complete the required operations for the mobile verify authentication routine and thus, the user may need to be authenticated using the non-mobile verify authentication routine as previously described in operation 408.

Additionally, or alternatively, in an instance in which the logon request failed to be authenticated, the communications hardware 206 may provide a logon error notification. A logon error notification may be indicative that the logon request failed to be successfully authenticated. In some embodiments, the logon request may be indicative of the reason for the authentication failure. The communications hardware 206 may provide the logon error notification to user device 106A. As such, the logon error notification may be indicative that the authentication for the provided logon request has failed and may prompt a user to retry or resubmit the logon request using different user credentials (e.g., a password, biometric data, PIN, and/or the like). In some embodiments, the user may retry or resubmit the logon request a predefined number of times (e.g., five times). After the predefined number of times has been exceeded, the user account may be temporarily locked to ensure security of the user account.

In an instance in which the logon request was successfully authenticated, the process proceeds to operation 418. As shown by operation 418, the apparatus 200 includes means, such as event management circuitry 208 or the like for determining whether the mobile verify event is associated with an active status. As described above, the status of a mobile verify event pertaining to the outbound call may be representative of whether the call and/or agent on the call is valid or authentic. In some embodiments, the mobile verify event may only be valid for a predefined time period to help maintain user account security.

In some embodiments, the communications hardware 206 may receive a cancellation request for the outbound call from agent device 108A. For example, the agent may fail to connect with the user or otherwise wish to cancel the outbound call and may therefore use agent device 108A to provide the cancellation request. The communications hardware 206 may receive this cancellation request and in response to receipt of such a request, the event management circuitry 208 may automatically update the mobile verify event to an inactive status. As such, this may prevent a mobile verify authentication routine from being performed for user device 106A and help maintain the integrity and security of the user account.

As described above, the mobile verify event may include a user identifier, a device identifier for user device 106A, an agent identifier, a device identifier for agent device 108A, and/or the like. In some embodiments, the event management circuitry 208 may identify the mobile verify event using the identifier (e.g., phone number), user device identifiers, or user identifier from the logon request. Additionally, or alternatively, the mobile verify event may be associated with the user account such that the event management circuitry 208 may determine the status of the mobile verify event using the user account.

In some embodiments, operation 418 may be performed in accordance with the operations described by FIG. 6. Turning now to FIG. 6, example operations are shown for determining whether to update an event status of the mobile verify event.

As shown by operation 602, the apparatus 200 includes means, such as processor 202, memory 204, event management circuitry 208, or the like, for determining an elapsed time indicative of a total time since the mobile verify event was generated. In some embodiments, the mobile verify event is associated with a generation timestamp that is indicative of the time the mobile verify event was generated. The event management circuitry 208 may then use the generation timestamp and a current time to determine the elapsed time.

As shown by operation 604, the apparatus 200 includes means, such as processor 202, memory 204, event management circuitry 208, or the like, for determining whether the elapsed time satisfies an elapsed time threshold. In some embodiments, the event management circuitry 208 is configured with an elapsed time threshold. The elapsed time threshold may control the duration for which the mobile verify event is valid for. The elapsed time threshold may be configured by one or more authorized agents. As such, the event management circuitry 208 may compare the elapsed time to the elapsed time threshold to determine whether the elapsed time threshold is satisfied. For example, the elapsed time threshold may be five minutes such that if the elapsed time exceeds five minutes, the event management circuitry 208 may determine the elapsed time threshold is not satisfied. As another example, the elapsed time threshold may be five minutes such that if the elapsed time is five minutes or less, the event management circuitry 208 may determine the elapsed time threshold is satisfied.

In an instance in which the elapsed time is determined to satisfy the elapsed time threshold, the process proceeds to operation 606. As shown by operation 606, the apparatus 200 includes means, such as processor 202, memory 204, event management circuitry 208, or the like, for updating the event status of the mobile verify event to an inactive status. The event management circuitry 208 may update the event status of the mobile verify event from active to inactive. This may help ensure the authenticity of the outbound call.

In some embodiments, the communications hardware 206 may provide an expiration notification to the agent device. The expiration notification may alert the agent that the mobile verify event is no longer valid. In some embodiments, the expiration notification may allow the agent device 108A to request a mobile verify event extension. In an instance in which the communications hardware 206 receives a mobile verify event extension, the event management circuitry 208 may create a new generation timestamp that is used to determine the elapsed time. Additionally, the event management circuitry 208 may update the event status of the mobile verify event to an active status.

In an instance in which the elapsed time is determined to satisfy the elapsed time threshold, the process proceeds to operation 608. As shown by operation 608, the apparatus 200 includes means, such as processor 202, memory 204, event management circuitry 208, or the like, for maintaining the event status of the mobile verify event. The event management circuitry 208 may maintain the event status of the mobile verify event in an instance in which the elapsed time satisfies the elapsed time threshold.

Returning now to FIG. 4, in an instance in which the mobile verify event is not associated with an active status, the process proceeds to operation 408. As previously described, at operation 408, the authentication circuitry 210 may perform a non-mobile verify authentication routine for the outbound call. If the mobile verify event is not associated with an active status, the authenticity of the outbound call and/or the agent may be unable to be confirmed by apparatus 200. Thus, the user may need to be authenticated using the non-mobile verify authentication routine as previously described in operation 408.

In an instance in which the mobile verify event is associated with an active status, the process proceeds to operation 420. As shown by operation 420, the apparatus 200 includes means, such as event management circuitry 208 or the like, for performing a mobile verify authentication routine. The mobile verify authentication routine may provide the user with call session context regarding the call they received such that trust may be established for the user regarding the authenticity of the call and agent. At the same time, the mobile verify authentication routine may leverage the current authenticated session established between user device 106A via the software application and apparatus 200. The mobile verify authentication routine may require the user to provide a call confirmation request that is indicative of whether he/she affirmatively confirms he/she received the call. The authentication circuitry 210 may then generate the authentication status of the user based on the call confirmation request. A user authentication message may be provided to agent device 108A such that the agent is informed of the current authentication status of the user. In doing so, the user may be authenticated without providing sensitive information to the caller and the agent may be informed of whether the user is successfully authenticated such that the agent may avoid revealing any sensitive information about the user or user account to users other than the intended user.

In some embodiments, operation 420 may be performed in accordance with the operations described by FIG. 7. Turning now to FIG. 7, example operations are shown for performing a mobile verify authentication routine. In some embodiments, the event management circuitry 208 may be configured to cause performance of each of the operations described in FIG. 7, such as by leveraging communications hardware 206 and/or authentication circuitry 210.

As shown by operation 702, the apparatus 200 includes means, such as event management circuitry 208 or the like for generating call session context for the outbound call.

The call session context may describe information pertaining to the outbound call to provide the user with further insight into the call. In some embodiments, the call session context may be indicative of agent information associated with the agent performing the outbound call, a reason for the outbound call, and/or associated content or documents pertaining to the outbound call. As described in operation 402 of FIG. 4, the communications hardware 206 may receive an outbound call request from agent device 108A. In some embodiments, the event management circuitry 208 may determine the call session context based on the outbound call request.

In particular, the outbound call request may describe a reason for the outbound call as provided by the agent. As such, the event management circuitry 208 may determine the outbound call reason directly from the outbound call request. For example, an outbound call reason may pertain to a user account activity inquiry (e.g., to verify suspicious account activity, account transactions, user-initiated changes to account settings, or the like), a promotional offer, a notification regarding a recent user account change (e.g., an alert about entity-initiated changes to a user account), a customer inquiry follow-up, a security notification (e.g., to notify the user of potential security breaches), a user account issue (e.g., to discuss overdue payments, account delinquencies, or the like), an account maintenance inquiry (e.g., updating outdated user account information, renewing expired documents, or the like), etc. In some embodiments, candidate reasons for the outbound call may be predefined categories that may be selected by the agent when providing the outbound call request. In some embodiments, the agent may further add supplemental reason information that pertains directly to the user. For example, the agent may select an outbound call reason of a “user account activity inquiry-verify suspicious account activity” and may provide supplemental reason information that describes the particular account activity from the user account that the agent wishes to verify.

Additionally, the outbound call request may include an agent identifier for the agent and/or device identifier for agent device 108A that provided the outbound call request. The event management circuitry 208 may use the agent identifier and/or device identifier to identify a corresponding agent account. The event management circuitry 208 may be configured to determine agent information from the agent account. For example, the event management circuitry 208 may determine agent information that includes an agent name, agent contact information (e.g., phone number, email address, fax number, or the like), agent department information, an agent picture, and/or the like. The event management circuitry 208 may further format the agent information accordingly to predefined formatting rules or guidelines. For example, the event management circuitry 208 may format an agent name of “Bob Franklin” to “Bob F.” in accordance with the predefined formatting rules. Additionally, in some embodiments, the predefined formatting rules may define different rules based on a particular agent, associated agent department, call context reason, and/or the like. This may help ensure a tailorable level of privacy for the agent when interacting with the customer.

In some embodiments, the outbound call request may further include dynamic agent context information. Dynamic agent context information may include one or more agent inquiries and corresponding responses and this dynamic agent context information may be used to instill confidence in the user that the agent is a verified agent. In addition to agent information, in some embodiments, the agent may configure his/her agent account with agent responses to agent inquiries. For example, an agent inquiry may be “who is your favorite football team” and the agent response may be “I like the NY Giants.” Each agent inquiry may be associated with a corresponding agent response. The agent account may be configured with a plurality of agent inquiries and corresponding agent responses. In some embodiments, the event management circuitry 208 may be configured to select a portion of the agent inquiries and corresponding agent responses as dynamic agent context information and include this in call session context. The event management circuitry 208 may be configured to change or randomize the selection of the agent inquiries and corresponding agent responses to reduce the likelihood that any would-be fraudster could replicate agent responses. The event management circuitry 208 may further provide an indication of the selected agent inquiries and agent responses to the agent device 108A, via communications hardware 206, such that the agent is made aware of the provided dynamic agent context. Once provided with the call confirmation request, the user may view the agent inquiries and agent responses and the agent may proactively inform the user of the agent responses to the agent inquiries, thereby increasing the user's confidence in the identity of the agent.

Furthermore, the event management circuitry 208 may include associated content or documents pertaining to the outbound call in the call session context. In some embodiments, the outbound call request may include associated documents and/or a reference to pertinent content as attached or included by the agent. Additionally, or alternatively, the event management circuitry 208 may automatically identify associated content and/or documents pertaining to the outbound call and include it in the call session context. In some embodiments, the event management circuitry 208 may identify associated content and/or documents based on the outbound call reason. In some embodiments, a predefined outbound call reason may be associated with content and/or documents. This may be maintained in memory 204 or another storage location. Thus, the event management circuitry 208 may access memory 204 or the associated storage location to determine the content and/or documents for the outbound call.

In some embodiments, content may refer to electronic information or media, such as a reference or link to user account data, a software application endpoint or page, a website page, entity-provided resources, and/or the like. In some embodiments, the content associated with a predefined outbound call reason may directly define a particular link or may provide instructions for the event management circuitry 208 for determining a link. By way of continuing example, an outbound call reason of a “user account activity inquiry—verify suspicious account activity” and may be associated with content that instructs the event management circuitry 208 to generate a link to recent user account transactions for the particular user account. As such, the event management circuitry 208 may automatically generate a link to a user account page that includes the user's most recent transactions. Once provided, the user may interact with this content (e.g., within the software application) to cause user device 106A to display the recent transaction of the user account within the software application or alternatively, user device 106A may automatically use the provided link to without user interaction.

In some embodiments, a document may refer to an electronic document. In some embodiments, the documents associated with a predefined outbound call reason may link to associated, stored documents or may provide instructions to event management circuitry 208 for generating a document and/or identifying a stored document. For example, for an outbound call reason of “account maintenance inquiry—renewing expired documents”, the associated instructions may instruct the event management circuitry 208 to identify the expired documents within the user account. As such, the event management circuitry 208 may analyze the user account to identify expired documents and include these documents and/or a link to these documents in the call session context. By way of continuing example, the documents associated with the predefined outbound call reason may further define one or more documents that a user may need to complete to replace the expired documents. As such, the event management circuitry 208 may include these new documents and/or a link to these documents in the call session context. In some embodiments, the new documents may include one or more input fields for one or more data fields that need to be populated. In some embodiments, the event management circuitry 208 may automatically populate one or more of these input fields based on the information in the user account, thereby reducing the burden on the user.

As shown by operation 704, the apparatus 200 includes means, such as communications hardware 206, event management circuitry 208, or the like, for transmitting a call confirmation request to the user device. Once the event management circuitry 208 has generated the call session context, the event management circuitry 208 may generate a call confirmation request that includes the call session context. Additionally, the call confirmation request may prompt the user to affirmatively confirm receipt of the outbound call. In particular, the confirmation request may include instructions that cause user device 106A to prompt the user to provide input to either confirm or deny whether he/she has received a call from an associated entity. The event management circuitry 208 may cause the communications hardware 206 to transmit or provide the call confirmation request to user device 106A via the software application. The user may view and/or interact with the call confirmation request within the software application. As such, this ensures that the user may only interact with the call confirmation request within the software application that has an authenticated session with apparatus 200. This ensures that if an affirmative confirmation of receipt of the call is received, it is received from a user who has been authenticated via a logon request such that the user may also be authenticated for the call.

In some embodiments, the communications hardware 206 may provide the call confirmation request using a HTTP/HTTPS protocol. In some embodiment, the communications hardware 206 may use specific APIs, such as RESTful APIs or WebSocket APIs to provide the call confirmation request to the user device 106A via the software application.

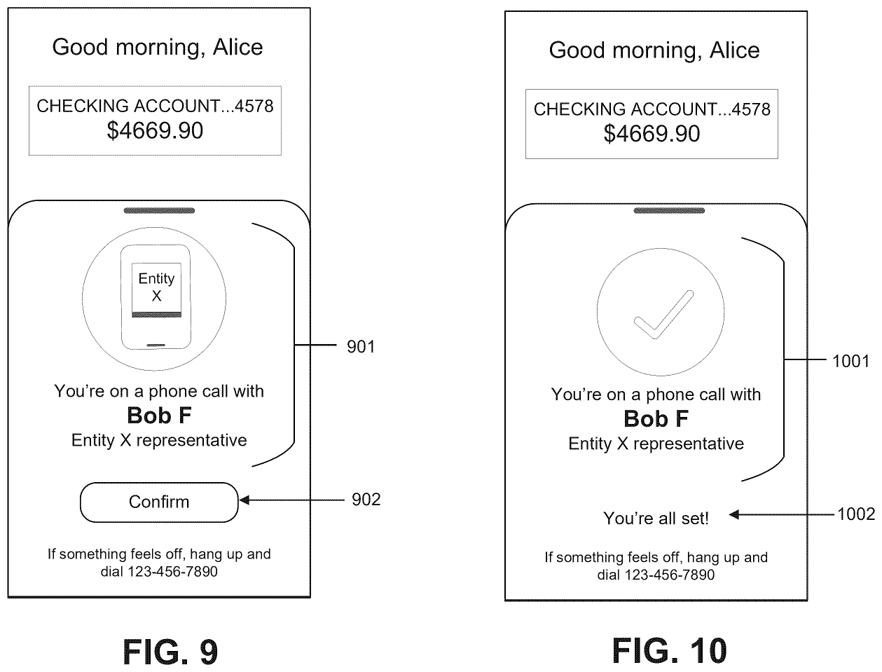

Turning to FIG. 9, a graphical user interface (GUI) is provided that illustrates an example call confirmation request. The GUI shown in FIG. 9 may be displayed to the user by the user device 106A within the associated software application. As shown in FIG. 9, the call confirmation request may include call session context 901 that provides information about the call. Additionally, the call confirmation request may include one or more interaction elements, such as interaction element 902. In an instance in which the user interacts with (e.g., clicks, touches, selects, audibly selects, or the like) interaction element 902, this may provide input indicative that the user has affirmatively confirmed receipt of the call. As such, the user device 106A may provide a call confirmation response as described in operation 706.

Returning now to FIG. 7, as shown by operation 706, the apparatus 200 includes means, such as communications hardware 206, event management circuitry 208, or the like, for receiving a call confirmation response from the user device. In some embodiments, the event management circuitry 208 may cause the communications hardware 206 to receive the call confirmation request, such as by instructing the communications hardware 206 to monitor for incoming communications. Once the communications hardware 206 has transmitted a call confirmation request to user device 106A, the communications hardware 206 may receive a call confirmation response from user device 106A. The communications hardware 206 may provide the call confirmation request to the event management circuitry 208. The call confirmation response may be indicative of whether the user has affirmatively confirmed receipt of the outbound call. For example, the user may provide input to user device 106A to interact with a “confirm” interaction element within the software application to confirm receipt of the outbound call such that the call confirmation request is indicative of this confirmation. If the user affirmatively confirms receipt of the outbound call, this may be indicative that the user and the agent were successfully connected for the outbound call. Alternatively, the call confirmation request may be indicative that the user has denied confirmation of the outbound call. This may be indicative that the user has not received the outbound call or did not answer the call.

In some embodiments, the communications hardware 206 may receive the call confirmation response using a HTTP/HTTPS protocol. In some embodiment, the communications hardware 206 may use specific APIs, such as RESTful APIs or WebSocket APIs to receive the call confirmation response from the user device 106A via the software application.

As shown by operation 708, the apparatus 200 includes means, such as event management circuitry 208, authentication circuitry 210, or the like, for determining whether the user has affirmatively confirmed receipt of the outbound call. In some embodiments, the event management circuitry 208 may cause the authentication circuitry 210 to determine whether the user has affirmatively confirmed receipt of the outbound call. As described above, the call confirmation request may include an indication of whether the user affirmatively confirmed receipt of the outbound call. In an instance the call confirmation request indicates that the user affirmatively confirmed receipt of the outbound call (e.g., provided user input confirming such), the authentication circuitry 210 may determine the user affirmatively confirmed receipt of the outbound call. In an instance the call confirmation request indicates that the user denied receipt of the outbound call (e.g., provided user input denying receipt), the authentication circuitry 210 may determine the user failed to confirm receipt of the outbound call. In some embodiments, the call confirmation request may be associated with a time limit such that in an instance a call confirmation response is not received within the time limit, the authentication circuitry 210 may automatically determine that the user has failed to affirmatively confirm receipt of the outbound call.

In an instance in which the user has failed to affirmatively confirm receipt of the outbound call, the process proceeds to operation 710. As shown by operation 710, the apparatus 200 includes means, such as event management circuitry 208, authentication circuitry 210, or the like, for generating a negative authentication status for the user. In an instance in which the authentication circuitry 210 determines the user failed to confirm receipt of the call, either explicitly within the call confirmation response or by determining the call confirmation response was not received within the time limit, the authentication circuitry 210 may generate an authentication status of “negative” for the user. The authentication status may serve as an indication of whether the user has been successfully authenticated for the outbound call as determined using the mobile verify authentication routine.

As shown by operation 712, the apparatus 200 includes means, such as event management circuitry 208 or the like, for updating a mobile verify event status to an inactive status. In an instance in which the authentication circuitry 210 generates an authentication status of “negative” for the user, the event management circuitry 208 may further update the mobile verify event status to an inactive event status. As such, the mobile verify event for the outbound call may be updated to be inactive due to the user's lack of affirmative confirmation of the outbound call. As such, this may cause the agent and/or agent device 108A to perform a non-mobile verify authentication routine for the call as described in operation 408 and maintain the security and integrity of the user's account. For example, if agent device 108A mistakenly performs an outbound call with a user device 106N that is not associated with the user, the user may deny receipt of the outbound call within the software application via user device 106A or may fail to provide any response such that the authentication circuitry 210 generates a negative authentication status for the user and the mobile verify event would be set to an inactive status. As described in further detail in operation 420, a negative authentication status and/or an inactive mobile verify event status would cause the agent and/or agent device 108A to perform the non-mobile verify authentication event or otherwise prohibit a different user associated with user device 106N to be authenticated on the call via the mobile verify authentication routine.

In an instance in which the user has affirmatively confirmed receipt of the outbound call, the process proceeds to operation 714. As shown by operation 714, the apparatus 200 includes means, such as event management circuitry 208, authentication circuitry 210, or the like, for generating a positive authentication status for the user. The event management circuitry 208 may cause the authentication circuitry 210 to generate a positive authentication status for the user. The authentication circuitry 210 may generate a positive authentication status for the user if the user has affirmatively confirmed receipt of the outbound call. A positive authentication status may serve as confirmation that agent device 108A has performed an outbound call with user device 106A that is associated with the user and the user has confirmed receipt of the outbound call within the software application via user device 106A. Thus, the authentication circuitry 210 may determine the user has successfully been authenticated via the mobile verify authentication routine such that the agent does not need to perform the non-mobile verify authentication routine. This may serve to streamline the authentication process for both the user and the agent.

Optionally, as shown by operation 716, the apparatus 200 includes means, such as event management circuitry 208, authentication circuitry 210, or the like, for determining a logon parameter set pertaining to the logon request. In some embodiments, the event management circuitry 208 may cause the authentication circuitry 210 to generate an authentication trust category for the user if the authentication circuitry 210 generates a positive authentication status for the user. To do so, the authentication circuitry 210 may determine a logon parameter set that may be used when generating the authentication trust score. In some embodiments, the logon parameter set may pertain to the logon request received from user device 106A. In particular, in some embodiments, the logon parameter set comprises one or more logon parameters that are indicative of whether the user device is a trusted device associated with a user account of the user, a current location of the user device, and/or an authentication protocol used to authenticate the logon request. A logon parameter may be associated with a value and a logon parameter field indicative of the corresponding type of logon parameter.

In some embodiments, the authentication circuitry 210 may determine one or more logon parameters based on the stored authentication protocol corresponding to the logon request received from the user device 106A. As described above, the authentication protocol used to authenticate the logon request may be stored in an associated memory, such as memory 204, and may describe the user credential type of the user credentials provided in the logon request, algorithms or models used in the authentication, associated matches or authentication scores (e.g., similarity scores), a number of logon request reattempts received from user device 106A, and/or the like. Thus, the authentication circuitry 210 may be configured to access the authentication protocol, such as from memory 204, and determine one or more logon parameters using the stored authentication protocol. In some embodiments, the values described by the authentication protocol may each correspond to a logon parameter field such that the authentication circuitry 210 may determine the value for the corresponding logon parameter field directly from the authentication protocol.

In some embodiments, the authentication circuitry 210 may determine one or more logon parameters based on a device profile corresponding to the user device 106A. As described above, in some embodiments, user device 106A may have a corresponding device profile that is associated with the user account. The device profile may include an associated device trust score that may be indicative of an inferred amount of trust or confidence that the user device is legitimately associated with or belongs to the user. In some embodiments, the device trust score may be a numerical value that falls within a range. In some embodiments, the authentication circuitry 210 may determine a device trust score as a logon parameter. In some embodiments, the authentication circuitry 210 may additionally, or alternatively, determine whether user device 106A is associated with a trusted user device status based on the associated device trust score. In particular, in some embodiments, the authentication circuitry 210 may determine whether the device trust score satisfies a device trust score threshold. In an instance the device trust score satisfies a device trust score threshold, the authentication circuitry 210 may determine user device 106A is associate with a trusted user device status and may determine the trusted user device status as a logon parameter.

In some embodiments, the authentication circuitry 210 may further determine one or more logon parameters based on a user device location for the user device 106A. In some embodiments, the user device location may be determined from the logon request, from the call confirmation request, or from shared location data provided by user device 106A. In some embodiments, the user device 106A may share its location when using the software application such that the communications hardware 206 may receive this location data from the user device 106A and authentication circuitry 210 may determine the user device location using this location data.

Optionally, as shown by operation 718, the apparatus 200 includes means, such as event management circuitry 208, authentication circuitry 210, or the like, for generating an authentication trust category for the user. An authentication trust category may be representative of a level of trust in the authentication of the user. Although users may be associated with an positive authentication status, the confidence in the user identity may be influenced by a variety of factors, such as how the user was authenticated, the trustworthiness of the user device 106A, compliance or deviation from known user patterns, and/or the like. In some embodiments, an authentication trust category may include very strong, strong, medium, weak, and very weak categories.

The authentication trust category may influence the actions that the agent is able to take with respect to the user account. For example, an action associated with a high risk may require a strong authentication trust category. This allows authentication circuitry 210 to provide flexibility to the mobile verify authentication routine by allowing users to be authenticated in an instance in which the affirmative confirmation is received but controls the level of access to a user account by limiting available user account actions based on the authentication trust score.

In some embodiments, the event management circuitry 208 may cause the authentication circuitry 210 to generate the authentication trust category using an authentication analysis model. In some embodiments, the authentication analysis model may be a rules-based model or a machine learning model that is configured to process the logon parameter set to generate an authentication trust category for the user. In some embodiments, the authentication analysis model may be configured to determine an intermediate score for each logon parameter. The intermediate score may be numerical, categorical, one-hot encoded, binary, and/or the like. The type of intermediate score may be dependent upon the corresponding logon parameter field. For example, an intermediate score for user credential logon parameter field pertaining to a user credential type of the user credentials provided in the logon request may be one-hot encoded (e.g., 0 for a password user credential, 1 for a PIN user credential, 2 for a biometric user credential, etc.).

In some embodiments, the authentication analysis model may process each logon parameter to determine an intermediate score and then use the intermediate scores to determine an aggregated authentication score. Alternatively, the authentication analysis model may skip determining intermediate scores and may directly determine the aggregated authentication score. The aggregated authentication score may be based on each user parameter. In some embodiments, the authentication analysis model may be configured with predefined thresholds for one or more logon parameter fields such that it may generate the authentication trust category based on a comparison between the values of the logon parameters, or corresponding intermediate values, to corresponding predefined thresholds. In some embodiments, the predefined thresholds may be determined by the authentication analysis model during training or retraining of the model.

The authentication analysis model may then generate the authentication trust category for the user based on the aggregated authentication score. In particular, the authentication analysis model may determine whether the aggregated authentication score satisfies one or more aggregated authentication score thresholds. The authentication analysis model may then generate the authentication trust category based on whether the aggregated authentication score satisfies or fails one or more of the one or more aggregated authentication score thresholds. For example, the authentication analysis model may be configured to generate a very weak authentication trust category for aggregated authentication scores at or below an aggregated authentication score threshold of 20, a weak authentication trust category for aggregated authentication scores between 20-40, a medium authentication trust category for aggregated authentication scores between 41-60, a strong authentication trust category for aggregated authentication scores between 61-80, and a very strong authentication trust category for aggregated authentication scores above 80.

The authentication analysis model may output the authentication trust category to the authentication circuitry 210 such that the authentication circuitry 210 may generate the authentication trust category for the user. For example, the authentication circuitry 210 may determine a user A that provides a logon request using a password user credential using a user device with a device trust score of 60 is associated with a medium authentication trust category. As another example, the authentication circuitry 210 may determine a user B that provides a logon request using a biometric user credential using a user device with a device trust score of 80 is associated with a strong authentication trust category.

Additionally, in some embodiments, the authentication circuitry 210 may enable the agent to perform particular actions for the user account based on the authentication trust category. Additionally, or alternatively, the authentication circuitry 210 may disable the agent from performing particular actions for the user account based on the authentication trust category. As described in more detail in operation 720, in some embodiments, the user may be provided with an opportunity to improve his/her authentication trust category, such as by performing additional authentication operations within the software application.

As shown by operation 720, the apparatus 200 includes means, such as communications hardware 206, event management circuitry 208, or the like, for transmitting a user authentication message to the agent device. The event management circuitry 208 may cause the communications hardware 206 to provide a user authentication message to the agent device 108A such that the user is made aware of the authentication status of the user and/or the authentication trust category determined for the user. In some embodiments, the communications hardware 206 may provide the user authentication message to the agent device 108A within the internal account environment using a HTTP/HTTPS protocol.

The agent device 108A may display the user authentication message to the agent such that the agent may be made aware of the authentication status (e.g., positive or negative) for the user and/or the authentication trust category determined for the user. If the user is non-authenticated, a non-mobile verify routine, as described in operation 408 may be performed. If the user is authenticated, the agent may be enabled to perform certain actions for the user. In some embodiments, as described above, the authentication circuitry 210 may enable the agent to perform particular actions for the user based on the authentication trust category determined for the user. In some embodiments, a set of predefined actions may be associated with each authentication trust category such that the authentication circuitry 210 may grant permissions to the agent device 108A to allow the agent to perform these actions for the user account.

In some embodiments, the user authentication message may further include actions the user and/or agent can perform to enhance the user's authentication trust category, thereby enabling the agent to perform additional actions for the user account. In some embodiments, these options may be presented to the agent and the agent may advise the user of the necessary steps to perform.

In some embodiments, the communications hardware 206 may further provide a confirmation message to the user device 106A within the software application. The confirmation message may be indicative of whether the user affirmatively confirmed receipt of the call. In some embodiments, the communications hardware 206 may provide updated call session context and/or agent messages to the user device 106A within the software application. As such, the communications hardware 206 may continuously provide updated confirmation and relevant information, media, documents, etc. via the mobile application that pertain to the call the user is on with the agent. This may enhance accessibility and communication between the user and agent for the duration of the call.

Turning first to FIG. 10, a GUI is provided that illustrates an example confirmation message. The GUI shown in FIG. 10 may be displayed to the user by the user device 106A within the associated software application. As shown in FIG. 10, the confirmation message may include call session context 1001 that provides information about the call. Additionally, the confirmation message may provide an indication of whether the user confirmed receipt of the call 1002.

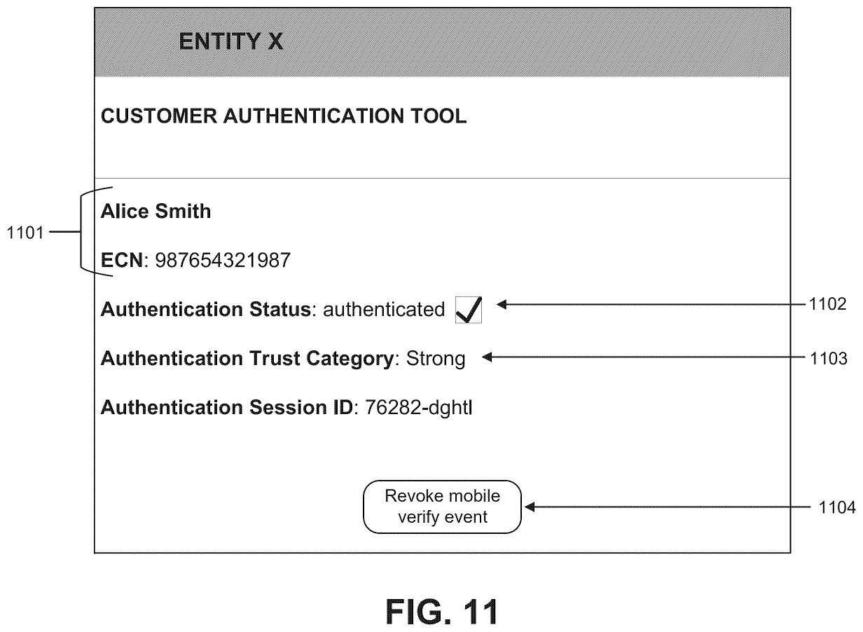

Turning next to FIG. 11, a GUI is provided that illustrates an example user authentication message. The GUI shown in FIG. 11 may be displayed to the agent by the agent device 108A within the internal account environment. In some embodiments, the user authentication message may be displayed within a particular software tool, plug-in, add-on, etc. As shown in FIG. 11, the user authentication message may include user information 1101 that provides information about the user on call. Additionally, the user authentication message may provide the authentication status 1102 and the authentication trust category 1103 generated for the user. Additionally, the user authentication message may also include one or more interaction elements, such as interaction element 1104. In an instance in which the user interacts with (e.g., clicks, touches, selects, audibly selects, or the like) interaction element 1104, this may provide input indicative that the agent desires to provide a session revocation request, as described in further detail in operation 722 of FIG. 7.

Returning now to FIG. 7, optionally, as shown by operation 722, the apparatus 200 includes means, such as communications hardware 206, event management circuitry 208, or the like, for receiving a session revocation request from the agent device. In some embodiments, the event management circuitry 208 may cause the communications hardware 206 to receive the session revocation request, such as by instructing the communications hardware 206 to monitor for incoming communications. In some embodiments, after the user has been successfully authenticated, the agent may wish to revoke the mobile verify session and terminate the call. For example, even in an instance the user is authenticated, the agent may become concerned that the party on the call is not the intended user. As described above, in some embodiments, the user authentication message may include a session revocation request interaction element. If the user interacts with this interaction element, the communications hardware 206 may receive the session revocation request from the agent device 108A, such as by using a HTTP/HTTPS protocol.

Optionally, as shown by operation 724, the apparatus 200 includes means, such as event management circuitry 208, authentication circuitry 210, or the like, for updating the authentication status for the user to a negative authentication status. In an instance in which the communications hardware 206 receives the session revocation request from the agent device, the event management circuitry 208 may cause the authentication circuitry 210 to update the authentication status for the user to a negative status. In some embodiments, the communications hardware 206 may further provide a user authentication message to the agent device 108A and/or confirmation message to the user device 106A to inform the agent and/or user of the updated authentication status. Additionally, the authentication circuitry 210 may revoke associated permissions for the agent to perform actions for the user account. In some embodiments, the communications hardware 206 may further terminate the authenticated session with user device 106A within the associated software application. As such, the security and integrity of the user's account may be maintained.

Optionally, as shown by operation 726, the apparatus 200 includes means, such as event management circuitry 208 or the like for updating the mobile verify event status to an inactive event status. Additionally, in response to receiving the session revocation request from the communications hardware 206, the event management circuitry 208 may update the mobile verify event status to an inactive status. As such, the mobile verify authentication routine may not be performed for the user device 106A unless the agent device 108A provides a new outbound call request.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

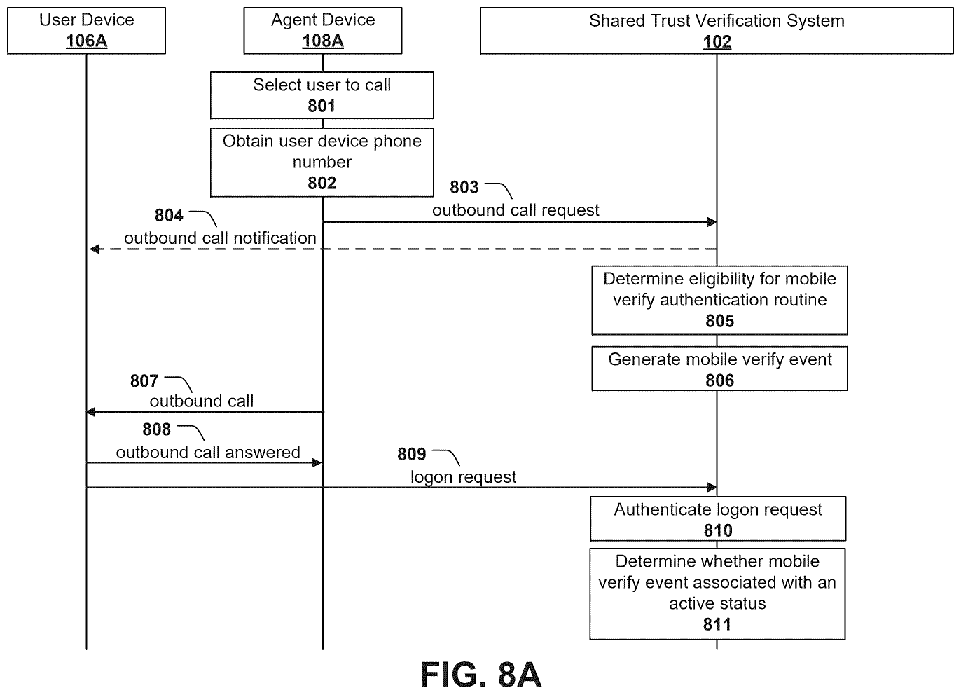

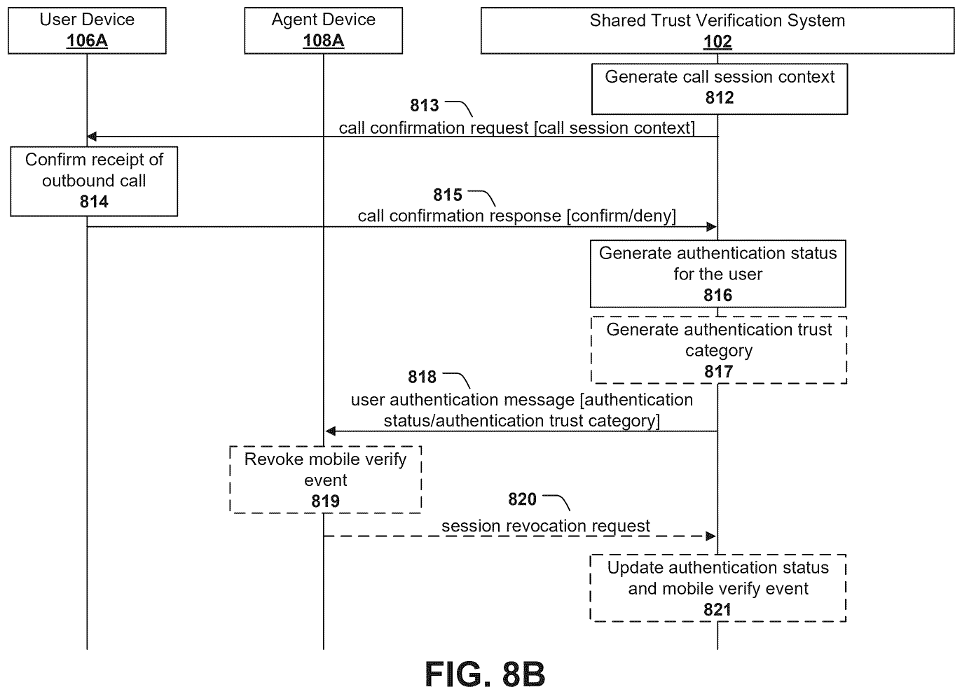

FIGS. 8A-8B show a swim lane diagram illustrating example operations (e.g., as described above in connection with FIGS. 4-7) performed by components of the environment depicted in FIG. 1 to produce various benefits of the implementations described herein. The operations shown in the swim lane diagram performed by user device 106A are shown along the line extending from the box labeled “User Device 106A,” operations performed by an agent device 108A are shown along the line extending from the box labeled “Agent Device 108A,” and operations performed by the shared trust verification system 102 are shown along the line extending from the box labeled “Shared Trust Verification System 102.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 8A-8B.

At operation 801, agent device 108A may receive input from the agent to select a user to call. At operation 802, agent device 108A may obtain a user device phone number (e.g., a device identifier) for a user device associated with the selected user. At operation 803, agent device 108A may provide an outbound call request to the shared trust verification system 102. Optionally, at operation 804, the shared trust verification system 102 may provide an outbound call notification to user device 106A. At operation 805, the shared trust verification system may determine whether the user device is eligible for the mobile verify authentication routine. At operation 806, in an instance in which the user device is determined to be eligible for the mobile verify authentication routine, the shared trust verification system 102 may generate a mobile verify event. At operation 807, agent device 108A may perform an outbound call to user device 106A. At operation 808, user device 106A may answer the outbound call such that user device 106A and agent device 108A are connected on a call. At operation 809, user device 106A may provide a logon request to the shared trust verification system 102. At operation 810, the shared trust verification system 102 may authenticate the logon request. At operation 811, the shared trust verification system 102 may determine whether the mobile verify event is associated with an active status.

Turning now to FIG. 8B, at operation 812, the shared trust verification system 102 may generate call session context. At operation 813, the shared trust verification system 102 may provide a call confirmation request that includes the call session context. At operation 814, user device 106A may affirmatively confirm receipt of the outbound call. At operation 815, user device 106A may provide a call confirmation response that includes affirmative confirmation or denial of the outbound call. At operation 816, the shared trust verification system 102 may generate an authentication status for the user based on whether the user affirmatively confirmed receipt of the outbound call. Optionally, at operation 817, the shared trust verification system 102 may generate an authentication trust category in an instance in which the user is associated with a “positive” authentication status. At operation 818, the shared trust verification system 102 may provide a user authentication message to agent device 108A. The user authentication message may include the authentication status and/or the authentication trust category determined for the user. Optionally, at operation 819, agent device 108A may receive input from the agent indicative to revoke the mobile verify event. Optionally, at operation 820, agent device 108A may provide a session revocation request to the shared trust verification system 102. Optionally, at operation 821, the shared trust verification system 102 may update the authentication status and/or mobile verify event based on the session revocation request.

### Conclusion

As described above, example embodiments provide methods and apparatuses that enable improved authentication for outbound calls. Example embodiments thus provide tools that overcome the problems faced by conventional methods that fail to provide the user with an indication of the authenticity of the outbound call and further, require authentication procedures that potentially expose sensitive user information. By leveraging the security and convenience enabled by a software applications on a user device, example embodiments avoid the need for a user to expose sensitive information to another party on the call while still enabling the user to authenticate him/herself on the call. Furthermore, example embodiments described herein provide for mutual trust to be established between the user and the agent by providing the user with an indication of the authenticity of the agent and the call itself, which has been absent from conventional outbound call procedures. Additionally, by automating functionality associated with the authentication process that has historically required human (e.g., agent) analysis and input, the speed, consistency, and accuracy of the authentication evaluations performed by example embodiments unlocks many potential new functions that have historically not been available, such as the ability to conduct near-real-time user authentication and agent permission enablement with respect to the user account.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for establishing shared trust between an agent and a user for an outbound call, the method comprising:
receiving, by communications hardware, an outbound call request from an agent device, wherein the outbound call request comprises (a) an identifier that identifies a user device associated with the user for the outbound call and (b) a request for a mobile verify authentication routine to be performed for the outbound call;
determining, by event management circuitry, that the user device is eligible for the mobile verify authentication routine; and
performing, by the event management circuitry, the mobile verify authentication routine by:
causing generation of a call session context for the outbound call based on the outbound call request,
causing transmission of a call confirmation request to the user device, wherein the call confirmation request comprises the call session context,
causing receipt of a call confirmation response from the user device, wherein the call confirmation response is indicative of whether the user has affirmatively confirmed receipt of the outbound call,
causing generation of an authentication status for the user, wherein the authentication status is set to a positive status in an instance in which the user has affirmatively confirmed receipt of the outbound call, and
causing transmission of a user authentication message to the agent device, wherein the user authentication message comprises the authentication status.

2. The method of claim 1, further comprising in an instance in which the user has affirmatively confirmed receipt of the outbound call, causing generation, by the event management circuitry, of an authentication trust category indicative of a level of inferred trust in an identity of the user, wherein the user authentication message further comprises the authentication trust category.

3. The method of claim 2, further comprising causing determination, by the event management circuitry, of a logon parameter set pertaining to a logon request received from the user device, wherein (a) the logon parameter set comprises one or more logon parameters that are indicative of one or more of (i) whether the user device is a trusted device associated with a user account of the user, (ii) a current location of the user device, or (iii) an authentication protocol used to authenticate the logon request and (b) the authentication trust category is generated based on the logon parameter set.

4. The method of claim 1, further comprising:
identifying, by the event management circuitry, one or more user device parameters associated with the user device;
determining, by the event management circuitry, whether the one or more user device parameters satisfy mobile verify requirement criteria;
in an instance in which the one or more user device parameters satisfy the mobile verify requirement criteria, determining, by the event management circuitry, the user device is eligible for the mobile verify authentication routine; and
in an instance in which the one or more user device parameters fail to satisfy the mobile verify requirement criteria, determining, by the event management circuitry, the user device is not eligible for the mobile verify authentication routine.

5. The method of claim 4, wherein the mobile verify requirement criteria requires at least that (a) the user device has previously accessed a user account via an associated software application, (b) the user account is indicative of consent to receive outbound calls, or (c) the user device is associated with a trusted user device status.

6. The method of claim 1, wherein the authentication status is set to a negative status in an instance in which the user has failed to affirmatively confirm receipt of the outbound call.

7. The method of claim 1, further comprising:
receiving, by the communications hardware, a session revocation request from the agent device; and
in response to receiving the session revocation request, causing an update, by the event management circuitry, to the authentication status for the user, wherein the update sets the authentication status to a negative status.

8. The method of claim 1, further comprising in response to determining that the user device is eligible for the mobile verify authentication routine, generating, by the event management circuitry, a mobile verify event for the outbound call, wherein an event status of the mobile verify event is initially set to an active event status.

9. The method of claim 8, further comprising:
determining, by the event management circuitry, an elapsed time indicative of a total time since the mobile verify event was generated; and
in an instance in which the elapsed time fails to satisfy an elapsed time threshold, updating, by the event management circuitry, the event status of the mobile verify event to an inactive event status.

10. The method of claim 1, further comprising, in response to receipt of the outbound call request, providing, by the communications hardware, an outbound call notification to the user device.

11. The method of claim 1, wherein the call session context is indicative of at least one of (a) a portion of agent information associated with the agent, (b) dynamic agent context information, (c) a reason for the outbound call, or (d) associated content or documents pertaining to the outbound call.

12. An apparatus for establishing shared trust between an agent and a user for an outbound call, the apparatus comprising:
communications hardware configured to receive an outbound call request from an agent device, wherein the outbound call request comprises (a) an identifier that identifies a user device associated with the user for the outbound call and (b) a request for mobile verify authentication routine to be performed for the outbound call; and
event management circuitry configured to:
determine whether the user device is eligible for the mobile verify authentication routine, and
perform the mobile verify authentication routine by:
causing generation of a call session context for the outbound call based on the outbound call request,
causing transmission of a call confirmation request to the user device, wherein the call confirmation request comprises the call session context,
causing receipt of a call confirmation response from the user device, wherein the call confirmation response is indicative of whether the user has affirmatively confirmed receipt of the outbound call,
causing generation of an authentication status for the user, wherein the authentication status is set to a positive status in an instance in which the user has affirmatively confirmed receipt of the outbound call, and
causing transmission of a user authentication message to the agent device, wherein the user authentication message comprises the authentication status.

13. The apparatus of claim 12, wherein in an instance in which the user has affirmatively confirmed receipt of the outbound call, the event management circuitry is further configured to cause generation of an authentication trust category indicative of a level of inferred trust in an identity of the user, wherein the user authentication message further comprises the authentication trust category.

14. The apparatus of claim 13, wherein the event management circuitry is further configured to cause determination of a logon parameter set pertaining to a logon request received from the user device, wherein (a) the logon parameter set comprises one or more logon parameters that are indicative of one or more of (i) whether the user device is a trusted device associated with a user account of the user, (ii) a current location of the user device, or (iii) an authentication protocol used to authenticate the logon request and (b) the authentication trust category is generated based on the logon parameter set.

15. The apparatus of claim 12, wherein the event management circuitry is further configured to:
identify one or more user device parameters associated with the user device;
determine whether the one or more user device parameters satisfy mobile verify requirement criteria;
in an instance in which the one or more user device parameters satisfy the mobile verify requirement criteria, determine the user device is eligible for the mobile verify authentication routine; and
in an instance in which the one or more user device parameters fail to satisfy the mobile verify requirement criteria, determine the user device is not eligible for the mobile verify authentication routine.

16. The apparatus of claim 15, wherein the mobile verify requirement criteria requires at least that (a) the user device has previously accessed a user account via an associated software application, (b) the user account is indicative of consent to receive outbound calls, or (c) the user device is associated with a trusted user device status.

17. The apparatus of claim 12, wherein the authentication status is set to a negative status in an instance in which the user has failed to affirmatively confirm receipt of the outbound call.

18. The apparatus of claim 12, wherein the event management circuitry is further configured to, in response to determining that the user device is eligible for the mobile verify authentication routine, generate a mobile verify event for the outbound call, wherein an event status of the mobile verify event is initially set to an active event status.

19. The apparatus of claim 18, wherein the event management circuitry is further configured to determine an elapsed time indicative of a total time since the mobile verify event was generated,
wherein in an instance in which the elapsed time fails to satisfy an elapsed time threshold, the event management circuitry is further configured to update the event status of the mobile verify event to an inactive event status.

20. A computer program product for establishing shared trust between an agent and a user for an outbound call, the computer program product comprising a non-transitory computer-readable storage medium storing instructions that, when executed by an apparatus, cause the apparatus to:
receive an outbound call request from an agent device, wherein the outbound call request comprises (a) an identifier that identifies a user device associated with the user for the outbound call and (b) a request for mobile verify authentication routine to be performed for the outbound call;
determine whether the user device is eligible for the mobile verify authentication routine; and
perform the mobile verify authentication routine by:
causing generation of a call session context for the outbound call based on the outbound call request,
causing transmission of a call confirmation request to the user device, wherein the call confirmation request comprises the call session context,
causing receipt of a call confirmation response from the user device, wherein the call confirmation response is indicative of whether the user has affirmatively confirmed receipt of the outbound call,
causing generation of an authentication status for the user, wherein the authentication status is set to a positive status in an instance in which the user has affirmatively confirmed receipt of the outbound call, and
causing transmission of a user authentication message to the agent device, wherein the user authentication message comprises the authentication status.
